(19) United States
(12) Patent Application Publication
(10) Pub. No.: US 2005/0270328 A1
(43) Pub. Date: Dec. 8, 2005

(54) Orientation film forming device, orientation film forming method, drawing device, and drawing method

(75) Inventor: Takahiro Usui, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/098,553

(22) Filed: Apr. 5, 2005

(30) Foreign Application Priority Data
Jun. 8, 2004 (JP) 2004-170105

(51) Int. Cl. B41J 2/145

(52) U.S. Cl. 347/40

(57) ABSTRACT

Aspects of the invention provide a drawing device and method that can improve the uniformity in film thickness after drying. The method can include a step of discharging orientation film ink from an ink jet head to a drawing region with a smaller area than a desired drawing region on a glass substrate a step of discharging the orientation film ink from the ink jet head to a peripheral drawing region which is a periphery of the drawing region, and a step of discharging the orientation film ink from the ink jet head to a peripheral drawing region which is a periphery of the peripheral drawing region are included. Accordingly, a protrusion of the orientation film ink after drying in the peripheral drawing region which is a rim part can be reduced.

### BACKGROUND

Aspects of the invention can relate to an orientation film forming device, an orientation film forming method, a drawing device, and a drawing method. More particularly, aspects of the invention can relate to orientation film forming device, an orientation film forming method, a drawing device, and a drawing method which can improve uniformity in film thickness after drying.

Related art ink-jet drawing devices can be a device which has an ink jet head provided with a number of nozzles in a subscanning direction, and that moves this ink jet head in a main scanning direction with a carriage mechanism to thereby perform drawing. Furthermore, the related art drawing device can be widely applied to not only the printing of letters and pictures/photographs, but also to the manufacturing of a color filter for use in color liquid crystal device and color electroluminescence (EL) display device. See, for example, Japanese Unexamined Patent Publication No. H9-138410.

In the ink-jet drawing device, based on dot pattern data obtained by expanding drawing data inputted from a host computer, ink is discharged from the respective nozzles of the ink jet head at predetermined timing and these respective ink droplets are applied to a drawing medium such as a glass substrate to thereby perform drawing.

FIG. 3 is a plan view and a cross-sectional view taken along the line A-A′ for explaining a drawing method using a related art drawing device. Hereinafter, a case where orientation film ink is applied to a glass substrate to form an orientation film with a predetermined shape and a predetermined film thickness (for example, 500 Å) is described. In the same figure, the drawing device discharges the orientation film ink to a quadrilateral drawing region 2 in a glass substrate 1 from the ink jet head. Here, the composition of the orientation film ink is such that a solvent (γ btyl lactone) is 98% and a solid content (polyimide) is 2%. Furthermore, the drawing region 2 is 11 mm wide and 16.5 mm long.

After the orientation film ink has been applied to the quadrilateral drawing region 2, the orientation film ink is dried via a first stage, a second stage and a third stage as shown in FIG. 4. More specifically, the first stage denotes a stage immediately after the orientation film ink is applied to the drawing region 2 of the glass substrate 1. Subsequently, in the second stage, a rim part 2a has been dried faster than a central part 2b (the solvent has evaporated), so that concentration gradient in the orientation film ink is generated. This allows the undried orientation film ink to move from the central part 2b with a lower concentration to the rim part 2a with a higher concentration, thereby further increasing the concentration in the rim part 2a as compared with the central part 2b.

Here, if a concentration is C, a diffusion coefficient is K, a time is t, a thickness of the orientation film ink is y, and a distance of wet spreading of the orientation film ink is x, a concentration change rate per unit time of the orientation film ink is represented by the formula (1).
∂C/∂t=K(∂²C/∂x²+∂²C/∂y²) (1)

Subsequently, in the third stage, since the rim part 2a and the central part 2b are dried and the concentration of the rim part 2a is higher, the rim part 2a is in a protruded state as compared with the central part 2b. For example, as shown in FIG. 3, a width W1 of a protruded part of the rim part 2a is 5000 Å. A protrusion height H1 is 3000 Å.

### SUMMARY

In the related art drawing device, as shown in FIG. 4, there is a problem in that since as the orientation film ink applied to the glass substrate 1 is being dried, the rim part 2a is being protruded as compared with the central part 2b, the uniformity in film thickness is low.

An aspect of the present invention can provide orientation film forming device, an orientation film forming method, drawing device, and a drawing method which can improve the uniformity in film thickness after drying. The invention can include a first ink discharging device for discharging orientation film ink to a drawing region with a smaller area than a desired drawing region on a substrate, and second ink discharging device for discharging the orientation film ink to a periphery of the drawing region.

Furthermore, the invention can include a first ink discharging step of discharging orientation film ink to a drawing region with a smaller area than a desired drawing region on a substrate, and a second ink discharging step of discharging the orientation film ink to a periphery of the drawing region.

Furthermore, the invention can include a first ink discharging device that discharges ink to a drawing region with a smaller area than a desired drawing region, and second ink discharging device that discharges the ink to a periphery of the drawing region.

Furthermore, the invention comprises a first ink discharging step of discharging ink to a drawing region with a smaller area than a desired drawing region, and a second ink discharging step of discharging the ink to a periphery of the drawing region.

According to the invention, since the ink is discharged to the drawing region with a smaller area than the desired drawing region and the ink is discharged to the periphery of the drawing region, the protrusion in the rim part can be reduced and the uniformity in film thickness after drying can be improved as compared with the case where the ink is discharged to the desired drawing region at a time as in the conventional case.

### BRIEF DESCRIPTION OF THE DRAWINGS

The invention will be described with reference to the accompanying drawings, wherein like numerals reference like elements, and wherein:

FIG. 1 is a block diagram showing a constitution of one exemplary embodiment according to the invention;

FIG. 2 is a plan view and a cross-sectional view taken along the line B-B′ for explaining a drawing method of the exemplary embodiment;

FIG. 3 is a plan view and a cross-sectional view taken along the line A-A′ for explaining a related art drawing method; and

FIG. 4 is a cross-sectional view for explaining a protrusion process of a rim part in the related art drawing method.

### DETAILED DESCRIPTION OF EMBODIMENTS

Hereinafter, an exemplary embodiment of orientation film forming device, an orientation film forming method, drawing device, and a drawing method according to the present invention is described in detail based on the drawings. However, it should be understood that this invention is not limited by this exemplary embodiment.

[Embodiment]

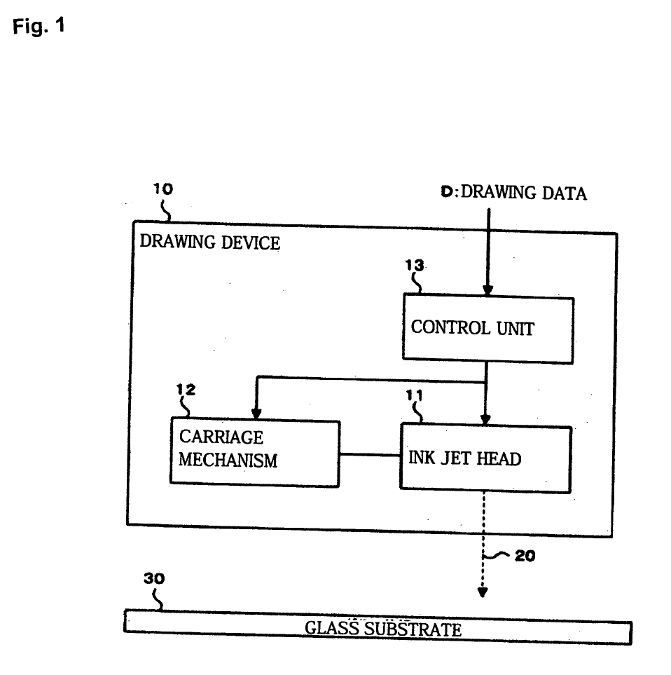

FIG. 1 is a block diagram showing an exemplary embodiment of the invention. In this figure, ink jet drawing device 10 is illustrated. In this drawing device 10, the ink jet head 11 can be provided with a number of nozzles in a subscanning direction, and has a function of discharging orientation film ink 20 to a glass substrate 30, for example.

A carriage mechanism 12 has a function of moving the ink jet head 11 in a main scanning direction. A control unit 13 has a function of performing control for discharging the orientation film ink 20 from the respective nozzles of the ink jet head 11 and control over the carriage mechanism 12 on the basis of dot pattern data obtained by expanding drawing data D inputted from a host computer (omitted in the figure).

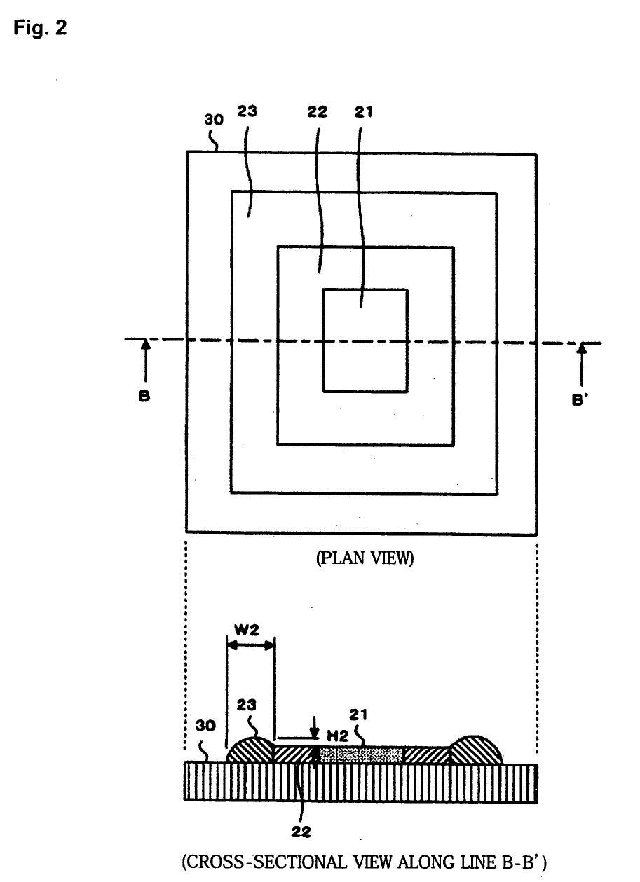

FIG. 2 is a plan view and a cross-sectional view taken along the line B-B′ for explaining a drawing method in an exemplary embodiment. Hereinafter, a case where the orientation film ink 20 is applied to the glass substrate 30 (refer to FIG. 1) from a central part to outward in several batches (in this figure, three times) to form an orientation film with a predetermined shape (for example, quadrilateral) and a highly uniform film thickness is described.

When the drawing data D as shown in FIG. 1 is inputted to the control unit 13, the control unit 13 expands the drawing data D into a dot pattern, and then as a first stage, the orientation film ink 20 is discharged from the ink jet head 11 to the quadrilateral drawing region 21 in the glass substrate 30 as shown in FIG. 2. Thereby, the orientation film ink 20 is applied to the drawing region 21. This drawing region 21 is 5 mm wide and 7.5 mm long.

Then, when a predetermined amount of the orientation film ink 20 applied to the drawing region 21 is dried, the control unit 13, as a second stage, causes the orientation film ink 20 to be discharged from the ink jet head 11 to a substantially square-shaped peripheral drawing region 22 which is a periphery of the drawing region 21. Thereby, the orientation film ink 20 is applied to the peripheral drawing region 22. This peripheral drawing region 22 is 8 mm wide and 8 mm long.

Then, when a predetermined amount of the orientation film ink 20 applied to the peripheral drawing region 22 (drawing region 21) is dried, finally, the control unit 13, as a third stage, causes the orientation film ink 20 to be discharged from the ink jet head 11 to a substantially square-shaped peripheral drawing region 23 which is a periphery of the peripheral drawing region 22. Thereby, the orientation film ink 20 is applied to the peripheral drawing region 23. This peripheral drawing region 23 is 11 mm wide and 16.5 mm long.

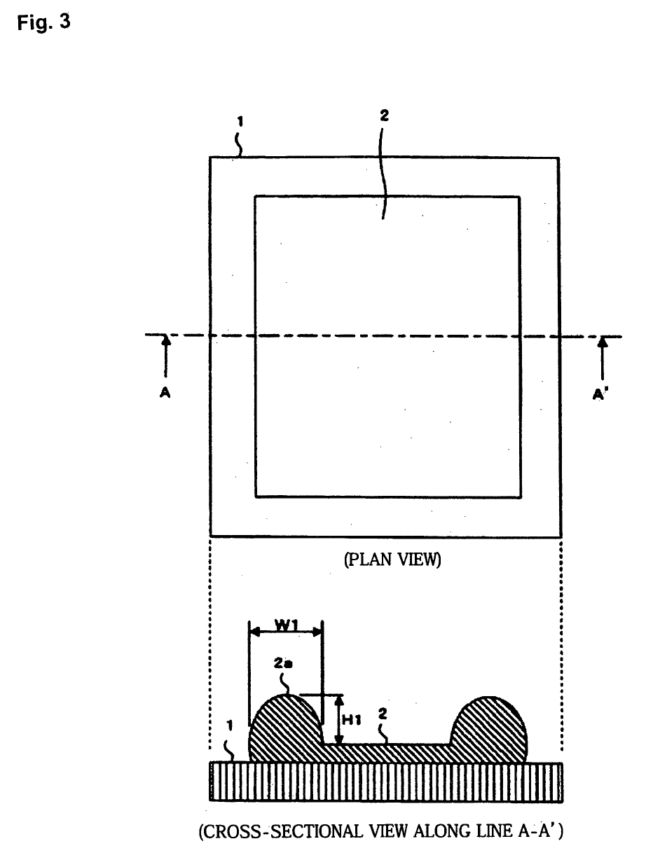

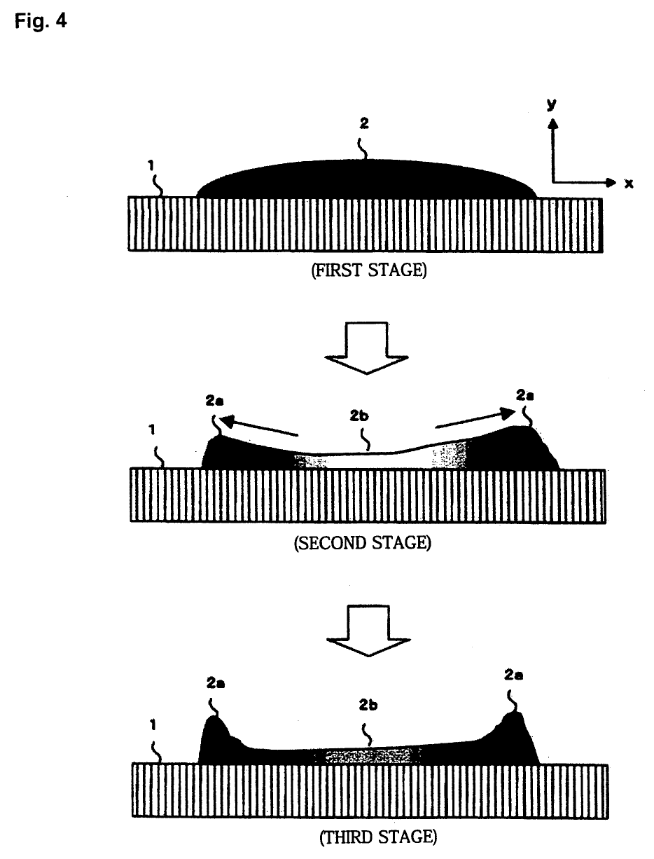

Then, when a predetermined time passes, the orientation film ink 20 can be applied to the drawing region 21, the peripheral drawing region 22 and the peripheral drawing region 23 is dried. Although this situation is in a state in which the peripheral drawing region 23 which is equivalent to a rim part is protruded, the degree of the protrusion is smaller than that in the conventional drawing method (refer to FIG. 4). Specifically, in the case in FIG. 2, a width W2 of a protruded part of the peripheral drawing region 23 (rim part) is 800 Å, which is a smaller value as compared with the width W1 of 5000 Å in the conventional case (refer to FIG. 3). Also, a protrusion height H2 is 50 Å, which is a smaller value as compared with the protrusion height W1 of 3000 Å (refer to FIG. 3).

As described above, according to an exemplary embodiment, since the orientation film ink 20 is discharged to the drawing region 21 with a smaller area than a desired drawing region and the orientation film 20 is discharged to the periphery of the drawing region 21 (peripheral drawing region 22, drawing region 23), the protrusion of the rim part (drawing region 23) can be reduced and the uniformity in film thickness after drying can be improved as compared with the case where the ink is discharged to the desired drawing region at a time as in the related art case.

As above, the orientation film forming device, the orientation film forming method, the drawing device, and the drawing method according to the present invention are useful in the case where the uniformity in film thickness is required.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

1. An orientation film forming device, comprising:
a first ink discharging device that discharges an orientation film ink to a drawing region with a smaller area than a desired drawing region on a substrate; and
a second ink discharging device that discharges the orientation film ink to a periphery of the drawing region.

2. The orientation film forming device according to claim 1,
the second ink discharging device discharging the orientation film ink to the periphery of the drawing region from an inner side to an outer side in several batches.

3. The orientation film forming device according to claim 1,
the second ink discharging device discharging the orientation film ink at predetermined time intervals.

4. An orientation film forming method, comprising:
discharging orientation film ink to a drawing region with a smaller area than a desired drawing region on a substrate; and
discharging the orientation film ink to a periphery of the drawing region.

5. Drawing device, comprising:
a first ink discharging device that discharges an ink to a drawing region with a smaller area than a desired drawing region; and
a second ink discharging device that discharges the ink to a periphery of the drawing region.

6. The drawing device according to claim 5,
the second ink discharging device, discharging the ink to the periphery of the drawing region from an inner side to an outer side in several batches.

7. The drawing device according to claim 6,
the second ink discharging device discharging the ink at predetermined time intervals.

8. A drawing method, comprising:
discharging ink to a drawing region with a smaller area than a desired drawing region; and
discharging the ink to a periphery of the drawing region.
